(19) United States
(12) Patent Application Publication
(10) Pub. No.: US 2011/0093376 A1
(43) Pub. Date: Apr. 21, 2011

(54) Combinatorial portfolio aggregations electronic trade

(76) Inventor: Danny Chan, New York, NY (US)

(21) Appl. No.: 12/589,295

(22) Filed: Oct. 21, 2009

(51) Int. Cl. G06Q 40/00

(52) U.S. Cl. 705/37

(57) ABSTRACT

A method for combinatorial portfolio aggregations in electronic trade transactions , in one example embodiment, comprises receiving data associated with an offer for possession of at least one part of an item for a period of time, receiving further data associated with at least one further offer for possession of the at least one part of the item for at least one further period of time, the time period and the at least one further period of time being non-concurrent, selectively aggregating the offer with the at least one further offer into a portfolio offer for the at least one part of the item, and based on predetermined criteria, determining that the portfolio offer is a winning portfolio offer.

### FIELD

This application relates generally to data processing, and more specifically to combinatorial portfolio aggregations in electronic trade.

### BACKGROUND

Electronic trade transactions such as online auctions and other types of monetary and non-monetary exchanges have become increasingly popular. A traditional online auction is the process of selling an item to the single highest bidder. At the end of the traditional online auction, the highest bidder becomes the owner of the item. The objective of the traditional online auction is to maximize the amount paid to the seller for the item. However, a potential buyer may only need the item for a certain period of time or after a certain date. In order to possess the item, the potential buyer is forced to buy the item outright. The seller, on the other hand, may only need to transfer the ownership of the item for a period of time or after a certain date. The traditional online auction is ill-suited to match these interests. Furthermore, the traditional online auction is ill-suited to create the market in which buyers are willing to share in non-concurrent (not occurring at the same time) ownership of the item.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computer-implemented method comprises receiving data associated with an offer for possession and/or usage of at least one part of an item for a period of time, receiving further data associated with at least one further offer for possession and/or usage of the at least one part of the item for at least one further period of time, the period of time and the at least one further period of time being non-concurrent, selectively aggregating the offer with the at least one further offer into a portfolio offer for the at least one part of the item, and based on predetermined criteria, determining that the portfolio offer is a winning portfolio offer.

In an example, the computer-implemented method further comprises awarding the at least one part of an item to one or more bidders associated with the winning portfolio offer. In an example, the awarding of the at least one part of the item is being conditional on the portfolio offer reaching a predetermined reserve price if a predetermined reserve price is set. In an example, a party associated with the offer can eliminate the at least one further offer when the portfolio offer exceeds the predetermined reserve price. In an example, the predetermined reserve price can be lowered by the seller. In an example, the aggregating continues until a predetermined time limit expires. In an example, the data associated with the offer includes an indication that the offer can be aggregated with the at least one further offer. In an example, the seller can select a minimum bid or the highest bidder can select a minimum bid amount from all other bidders within his portfolio of bids.

In an example, the period of time and the at least one further period of time can be selected from a group consisting of temporary periods of time and a permanent period of time. In an example, the method further enables a party associated with the permanent period of time to control the aggregation of the portfolio bid. In an example, the permanent period of time starts on a predetermined future date. In an example, the item can be automatically selected from at least one listing of a product, the product being a plurality of items similar to the item. In an example, the offer is a monetary, non-monetary, or an offer for exchange of goods and/or services. In an example, the method further comprises informing the parties associated with the offer and the at least one further offer that the acceptance includes the agreement to pay predetermined fines upon defaulting.

In further examples, the above methods steps are stored on a machine-readable medium comprising instructions, which when implemented by one or more processors perform the steps. In yet further examples, subsystems or devices can be adapted to perform the recited steps. Other features, examples, and embodiments are described below.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing sample network environment within which systems and methods for combinatorial portfolio aggregations in electronic trade are implemented, in accordance with an example embodiment;

FIG. 2 is a block diagram showing a electronic trade engine, in accordance with an example embodiment;

FIG. 3 is a flow chart showing a method for combinatorial portfolio aggregations in electronic trade, in accordance with an example embodiment;

FIG. 4 is a flow chart showing a method for combinatorial portfolio aggregations in electronic trade, in accordance with an example embodiment;

FIG. 5 is a flow chart showing a method for combinatorial portfolio aggregations in electronic trade, in accordance with an example embodiment;

FIG. 6 is a flow chart showing a method for combinatorial portfolio aggregations in electronic trade, in accordance with an example embodiment;

FIG. 7 is a flow chart showing a method for combinatorial portfolio aggregations in electronic trade, in accordance with an example embodiment; and

FIG. 8 is a diagrammatic representation of an example machine in the form of a computer system within which a set of instructions for causing the machine to perform any one or more of the methodologies discussed herein is executed.

### DETAILED DESCRIPTION

Example methods and systems for combinatorial portfolio aggregations in electronic trade are described. In the following description, for purposes of explanation, numerous specific details are set forth in order to provide a thorough understanding of example embodiments. It will be evident, however, to one skilled in the art that the present invention may be practiced without these specific details.

In some example embodiments, methods and systems for combinatorial portfolio aggregations in electronic trade can be utilized to conduct online trades in which buyers bid on one or more periods of time of non-concurrent possessions of a product or the non-concurrent possessions of one or more parts of the product. The product can comprise one or more of similar items listed by one or more sellers. The possessions can comprise a period of temporary possession, ownership commencing at the conclusion of a transaction, ownership commencing after one or more temporary possessions, and a delayed ownership. The systems and methods described herein can be utilized in monetary and non-monetary trades.

In a traditional online auction, the auction winner receives complete ownership of the item at the conclusion of the auction. In case of an auction for lease, the auction winner takes possession of the item and the ownership reverts back to the seller at the conclusion of the lease or the lessee can have an option of buying the item at the end of the lease. Thus, potential buyers must compete for the item notwithstanding the fact that they may not need to possess the item simultaneously. The methods and systems for combinatorial portfolio aggregations in electronic trade can permit bidders to bid for possessions of the item for respective non-concurrent time periods and at the same time to increase the bid amount by aggregating their respective bids. Thus, for example, one student may bid to acquire a textbook for one semester and another student may bid acquire the textbook for another semester and the aggregated bid will include the sum of both bids.

Thus, in some example embodiments, methods and systems for combinatorial portfolio aggregations in electronic trade can permit multiple bidders to bid as a group and aggregate their individual bids in a group portfolio bid. When the group portfolio bid is declared the winning bid, the group of bidders associated with the winning bid share in the non-concurrent ownership of the item. The ownership of the item is divided between the members of the group according to the time periods associated with their respective bids. In some example embodiments, one member of the group can be the final owner of the item. In further example embodiments, ownership of the item will revert to the seller once all temporary possessions by the members of the group expire.

In some example embodiments, the seller can offer long-term contracts on when and how to sell, to which buyers, and the criteria by which the final owner is selected. Hence, the transaction can be the final sale where the seller no longer owns the item or has the lease and where the seller or a member of the winning portfolio receives the item back after a pre-determined period of time. The highest bidder may not be the winning bidder because the item can be awarded to a portfolio bid rather than to individual bidders. Additionally, the highest bidder may not be the final owner because, for example, either the seller reserves the eventual ownership or the bid for the eventual ownership is not the highest bid in the winning portfolio. The item being sold can be of any physical or digital format. The item is not limited to physical items and can include a service.

In some example embodiments, once the auction commences, the bidder that desires to assume the eventual ownership of the item can start a bidding portfolio and then permit other bidders to aggregate their bids with his bid. In some example embodiments, the bidder can provide such permission to aggregate implicitly by entering the date on which he needs to start owning the item. Others bidders can join the bidding portfolio by bidding on possessions of the item for time periods expiring prior to the date specified by the bidder. It will be understood that the approaches described herein are not limited to auctions and can be implemented in other types of transactions, for example, in sales.

In some example embodiments, bidders can bid to replace existing bidders within the same portfolio bid, thereby increasing the aggregated bid amount. A bidder not willing to join an existing bidding portfolio can start a new bidding portfolio. In some example embodiments, at the end of the auction, the eventual ownership bidder can eliminate some bids from the portfolio. For example, when the aggregated bid amount is the highest portfolio bid and exceeds the published reserve price, some bids can be eliminated while ensuring the aggregated bid is still the highest bid. Thus, a bidder can create a new portfolio bid. Ousted bidders can join other portfolios or start a new portfolio bid at their preferred bid amount, provided that the auction has not expired.

In some example embodiments, buyers can bid on a product within a portfolio bid by selecting a reserve price and time by which they wish the transaction to occur. If the time selected by the bidder exceeds the auction's expiration date and the portfolio bid is not the winning bid or no bid wins at all, the seller can choose to repost the product and include the bid in a new portfolio bid for the item. In some example embodiments, the seller can aggregate and transact even though the reserve price is not reached. In such case, the seller may retain the ownership of the item.

In some example embodiments, the buyer can specify a reserve price to own the item without specifying the expiration date of the bid. If more than one buyer bids to own, the highest bidder can choose to resell to the lower bidders after a certain period of time. For example, in the case of college textbooks, the highest bidder can resell to the lowest bidders after 5 months. In some other example embodiments, the highest bidder can start and/or assume the ownership of the bidding portfolio regardless of whether or not such bidder bids for the eventual ownership of the item. In some example embodiments, a portfolio bid can be lacking a bidder for the eventual ownership of the item. In such case, the eventual ownership will revert to the seller.

In some example embodiments, the seller may be willing to sell an item after a future date. The potential buyers may not be certain whether or not they need the item after this future date. To facilitate the sale process, the seller can offer an option contract in which a potential buyer pays a fee for the right to complete the transaction. In some other example embodiments, the buyer can charge a predetermined fine if a buyer defaults and the transaction does not occur.

In some example embodiments, the owner of the item can permit bidders to bid money and at the same time permit sharing and/or giving away the item free of charge for the periods of time with no existing money bidders. In such case, a bidder can bid $0.

It will be understood that in some embodiments, the auction process can be set up as to enable the seller to select the buyer based on numerous criteria besides the amount of the monetary bid. These criteria can also include creditworthiness of the bidder. For example, the seller can prefer potential buyers with funded escrow accounts. Other criteria can also include buyer's reputation assessed based on the feedback provider by the user community.

It will be further understood that methods for combinatorial portfolio aggregations in electronic trade, described herein, are not limited to aggregations of bids based on the bids for non-concurrent possessions. Other aggregations enabling the buyer to pay less and still be able to own or use the item are possible. Additionally, unlike the traditional auctions or sales, the seller can lower the price to complete the transaction after the auction time has expired.

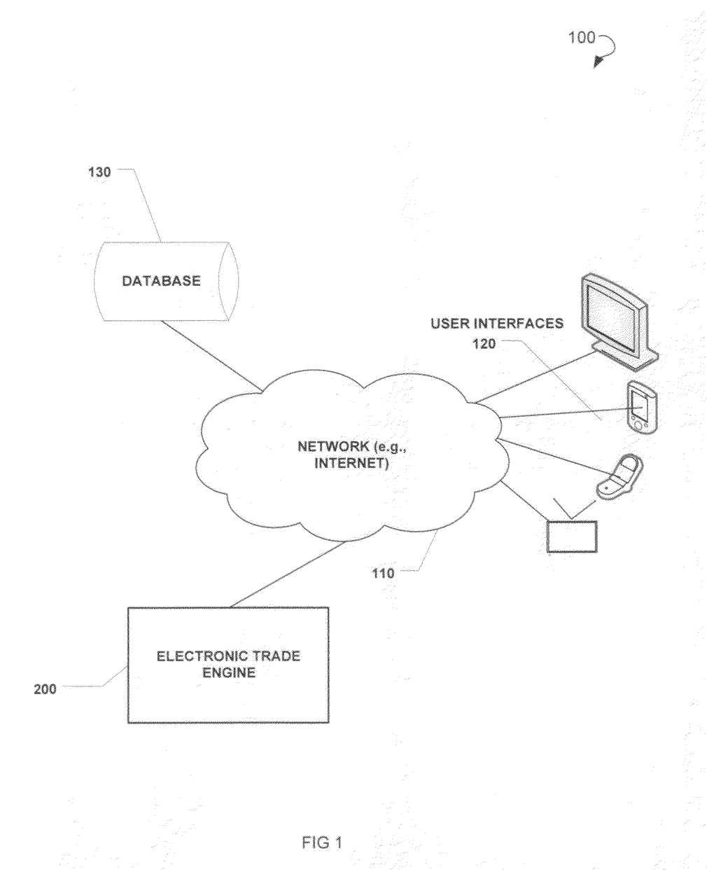

FIG. 1 is a block diagram showing a sample network environment 100 within which a system and method for combinatorial portfolio aggregations in electronic trade can be implemented, in accordance with an example embodiment. As shown in FIG. 1, the sample network environment 100 may comprise a network 110, user interfaces 120, a database 130, and an electronic trade engine 200. The network 110 can comprise a plurality of data processing nodes interconnected for the purpose of data communication. Other components of the network environment 100 can utilize the network 110 to receive, transmit, and store data as well as for the purpose of accessing remote resources.

The database 130 may be utilized to store data processed by the electronic trade engine 200. In some example embodiments, the data stored in the web database 130 can originate in transactions external to the electronic trade engine 120. The database 130 can also store data related to various market participant, which are the parties to the transactions. Such market participants can include buyers, sellers, auction bidders, auction watchers, or any other parties to online transactions. The user interfaces 120 can be included in various devices to facilitate transmitting and receiving data over the network 110. The user interfaces 120 can permit the market participants to interact with the electronic trade engine 200.

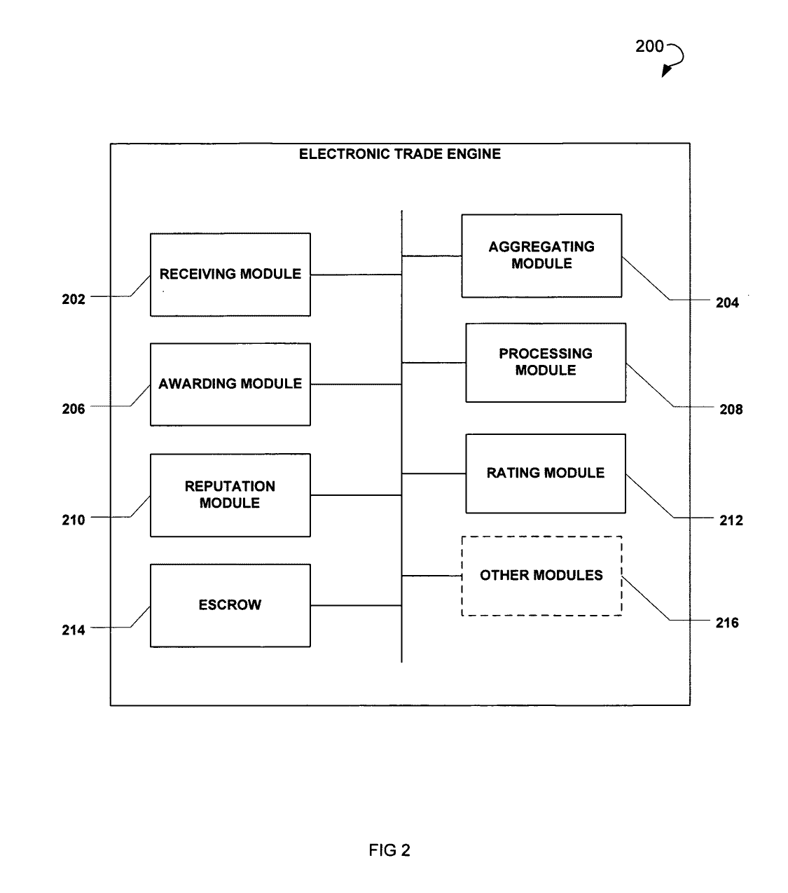

The electronic trade engine 200 can be utilized to process e-commerce transactions. The e-commerce transactions may comprise buying and selling of products or services over electronic systems such as the Internet and other computer networks. A wide variety of e-commerce may be conducted electronically over the network 110 and processed by the electronic trade engine 200. The transactions may include transfers of funds, online transaction processing, electronic data interchange, automated inventory management, and automated data collection. The electronic trade engine 200 can use the network 100 at least at some point in the transaction's lifecycle, although it may comprise a wider range of technologies. The electronic trade engine 200 is described by way of example with reference to FIG. 2.

FIG. 2 is a block diagram showing the electronic trade engine 200, in accordance with an example embodiment. The electronic trade engine 200 can include several components that may be configured to perform various operations. As show in FIG. 2, the electronic trade engine 200 can comprise a receiving module 202, an aggregating module 204, an awarding module 206, a processing module 208, a reputation module 210, a rating module 212, an escrow module 214, and other optional modules 216. The components of the electronic trade engine 200 can facilitate an online trade transaction such, for example, an auction. In a typical online auction process, the receiving module 202 can receive the data related to a listing posted by the seller as well as the data related to bids by the potential buyers.

The processing module 208 can process the data related to the rules of the auction and facilitate enforcement of such rules. The data can be stored in the database 130. The seller can specify the auction form, including time limits, minimum or maximum limits on bid prices, and special rules for determining the winning bidder(s) and sale price(s). The processing module 208 can facilitate the auctioning process according the nature of the auction and the settings specified by the seller. The auction can be direct, in which the seller is the offering party and the goal of the bidding is to drive the price up or reverse, in which the traditional roles of buyers and sellers are reversed, and the goal of bidding is to drive the price down.

Participants in an auction may or may not know the identities or actions of other participants. The methods for combinatorial portfolio aggregations in electronic tread can permit bidders to increase the bid amount by combining their bids in a portfolio bid. The aggregation of the bids is facilitated by the aggregating module 204. These methods are described in more detail below. The methods and systems for combinatorial portfolio aggregations in electronic trade are not limited to auctions and in, some example embodiments, can be utilized in exchange of goods and/or services for other goods and/or services without a common unit of exchange. The awarding module 206 facilitates determination of the winning bid or the winning portfolio bid.

In some example embodiments, the reputation module 210 can enable the seller to take into account the reputation of the potential buyer. For example, if the reputation module determines that the potential buyer has a poor reputation for making timely payments, the bid associated with the potential buyer can be assigned lesser weight than the bid associated with a potential buyer having higher reputation for making timely payments.

Similarly, the escrow module 214 can be utilized to take into account whether or not the escrow associated with the bidder is funded by assigning a higher weight to the bid associated with a funded escrow. Other modules 216 can be utilized to assign higher or lower weight to specific bids based on predetermined criteria. The rating module 212 can assess the data produced by the reputation module 210, the escrow module 214 and the other modules 216 and assign an aggregated weight to a particular bid. Aggregated weights in conjunction with the monetary values associated with multiple bids can enable the buyer to select the winning bidder.

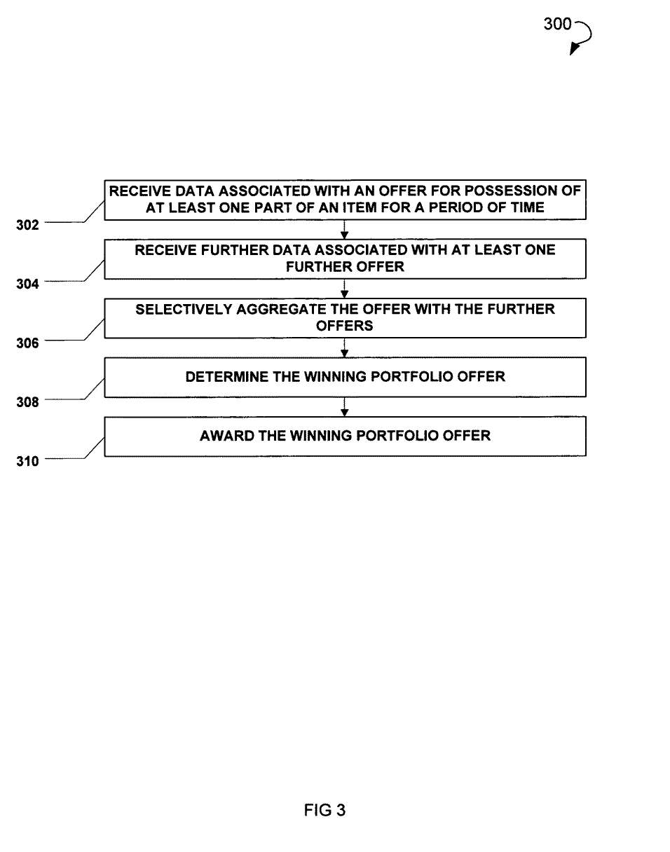

FIG. 3 is a flow chart showing a method 300 for combinatorial portfolio aggregations in electronic trade, in accordance with an example embodiment. The method 300 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2.

The method 300 may be performed by the various modules discussed above with reference to FIG. 2. Each of these modules may comprise processing logic. The method 300 may commence at operation 302 with the receiving module 202 receiving data associated with an offer for possession of at least one part of an item for a period of time. For example, in an online auction for a textbook, a bidder can specify a period of time coinciding with the term of college semester. To facilitate placing such bid, the user interfaces 120 can utilize a time slide associated with the listing. The bidder can bid to own the item at the conclusion of the auction. In such case, the processing module 208 can automatically determine that the bid is not to be aggregated with other bids. The bidder can also bid to own the item starting at a specific future date.

In some example embodiments, the bidder can indicate that his bid is not to be aggregated with other bids. If this is the case, the bid will not be aggregated with further bids. Otherwise, at operation 304, the receiving module 202 can receive further data associated with at least one further bid where the at least one further bidder selects to participate in the bid portfolio started by the first bidder. A further bidder can select a period of time which is not currently occupied by any bid or bid to replace the existing bidder in the same period of time. In some example embodiments, the bid to own the item starting at a specific future date can also be replaced by a higher bid.

At operation 306, the aggregating module 204 can aggregate the bids for the item in a portfolio bid. The portfolio bid can include the highest bids for non-concurring time periods and the highest bid to own the item starting at a specific future date. At operation 308, the processing module 208 can determine the winning portfolio offer among a plurality of portfolio offers and at operation 310 the awarding module 206 can award the item to the winning portfolio offer.

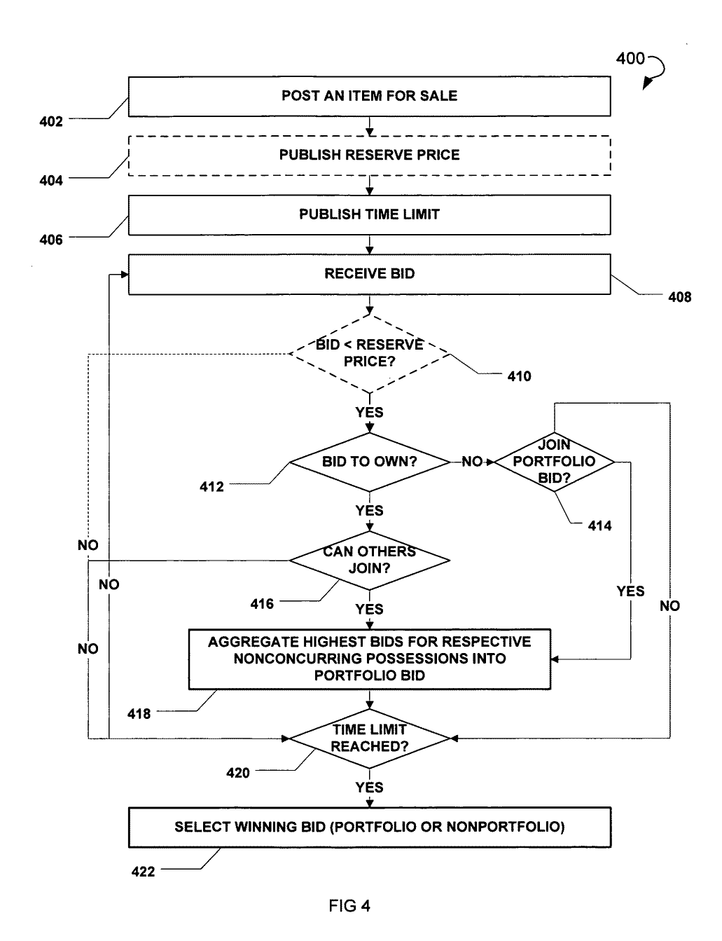

FIG. 4 is a flow chart showing a method 400 for combinatorial portfolio aggregations in electronic trade, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic trade engine 200 illustrated in FIG. 2. The method 400 may be performed by the various modules discussed above with reference to FIG. 2. Each of these modules may comprise processing logic.

The method 400 may commence at operation 402 with a seller posting an item for sale via one of the user interfaces 120. In some example embodiments, the seller can condition the sale upon a single bid or a portfolio bid exceeding a predetermined published reserved price. The reserve price can be published at operation 404. For example, the seller can specify that he reserves the right to cancel the sale unless a stand alone or/and a portfolio bid posted within 10 days equals or greater than $100. The time limit of the sale can be published at operation 406.

At operation 408, the receiving module 202 of the electronic trade engine 200 can receive a bid for the item. If the buyer is creating his own portfolio, the buyer can specify the minimum bid amount. For example, the buyer can specify that the minimum bid amount is $2.This approach can later save buyer some time while eliminating the unnecessary bids. However, if another higher bidder outbids the buyer in his own portfolio, the criteria set by the new highest bidder will apply.

At decision block 410, the processing module 208 can decide whether or not the bid equals or greater the published reserve price. In some example embodiments, a bid placed within the specified time limit becomes the winning bid unless there is a higher portfolio or a non-portfolio bid. If the processing module 208 determines that the bid is equal or greater the published reserve price, the method 400 can proceed to decision 420 where it is determined whether the time limit of the auction has been reached. If the time limit has not been reached the method 400 can continue to accept bids at operation 408. If on the other hand the time limit has been reached at, the method 400 will proceed to operation 422 at which the winning bid is selected by the awarding module 206.

If, on the other hand, the bid is less than the reserve price, the method 400 can proceed to operation 412, in which the processing module 208 can determine whether or not the bid is to own the item starting at a specified time.

If it is determined at operation 412 that the bid is to own the item, the method 400 can proceed to decision block 416 where it can be determined by the processing module 208 whether other bids can be aggregated with this bid into a portfolio bid. The bidder can explicitly specify that the bid is not to be aggregated. If this is the case, the method can proceed to decision block 420 where it is determined whether the time has expired. If it is determined that the time has expired, the method 400 can proceed to operation 422, where upon conclusion of the auction the winning bid is determined.

Referring back to operation 412, if on the other hand, it is determined that bid is not to own, the method 400 can proceed to decision block 414 where it can be determined whether or not the buyer wants to join an existing portfolio bid. If the buyer wants to join an existing portfolio bid, the bid will be placed within the context of the portfolio bid in which it will compete for a specific time period.

In some example embodiments, the bidder can join the portfolio bid having the lowest current bid for the desired time period out of a plurality of portfolio bids. The bidder can make a proxy bid for the desired time period by specifying the maximum price he is willing to pay. If it is determined that the bidder wants to join an existing portfolio bid, the bid is placed with an existing portfolio bid and the method 400 proceeds to operation 422, in which the winning bid is determined.

In some example embodiments, a losing bidder of a lower portfolio bid can request to join the winning portfolio bid by sending a request to the seller or the highest bidder of the winning portfolio if there is no conflict of interest with the current bidders. The losing bidder can also start another portfolio from the start to ensure better chances of being in the winning group.

Referring back to operation 412, if it is determined that the bidder wishes to place a bid to own the item, the bidder can decide at decision block 416 whether or not he prefers for his bid to be aggregated with other bids in an existing portfolio bid. In some example embodiment, the bidder can select not to join any existing portfolio bids notwithstanding the fact that the bid is less than the reserve price. At the completion of the auction, the seller can choose to award the item to the bidder due to the lack of higher bids. If, however, the bidder permits other bids to be aggregated with his bid, the method can proceed to operation 418.

At operation 418, the aggregating module 204 can aggregate the highest bids for respective non-concurring possessions into a portfolio bid. At decision block 420, the processing module 208 can decide whether or not the time limit for the auction is reached. If it is decided that the time limit is reached, the method can proceed to select the winning bid among the portfolio and non-portfolio bids. In some example embodiments, before the winning bid is selected, the highest bidder of the portfolio bid can eliminate one or more bids if the published reserve price is exceeded by the portfolio bid.

In some example embodiments, the seller can eliminate one or more bidders if the published reserve price is not reached and choose to transact with the remaining bidders. For example, the seller can eliminate the bidder bidding to own and then lease the item to the remaining bidders according to the placed bids. Upon completion of all lease periods, the ownership of the item reverts to the seller. If on the other hand, it is determined that the time limit is not reached, the method can return to operation 408 and receive a further bid.

Once the winning portfolio bid is selected, the possession of the item can be transferred from the seller to the first chronological owner by the seller within a predetermined time period. Each consecutive owner (if more than one) can be made responsible for the next respective transfer to the next chorological owner until the item is transferred back to the seller or is transferred to the eventual owner. The specifics of each transfer can agreed upon by the buyer, for example, at time the bid is placed. These specifics can spell out, for example, the party responsible for the shipping costs and the party responsible in case the item does not reach its intended destination.

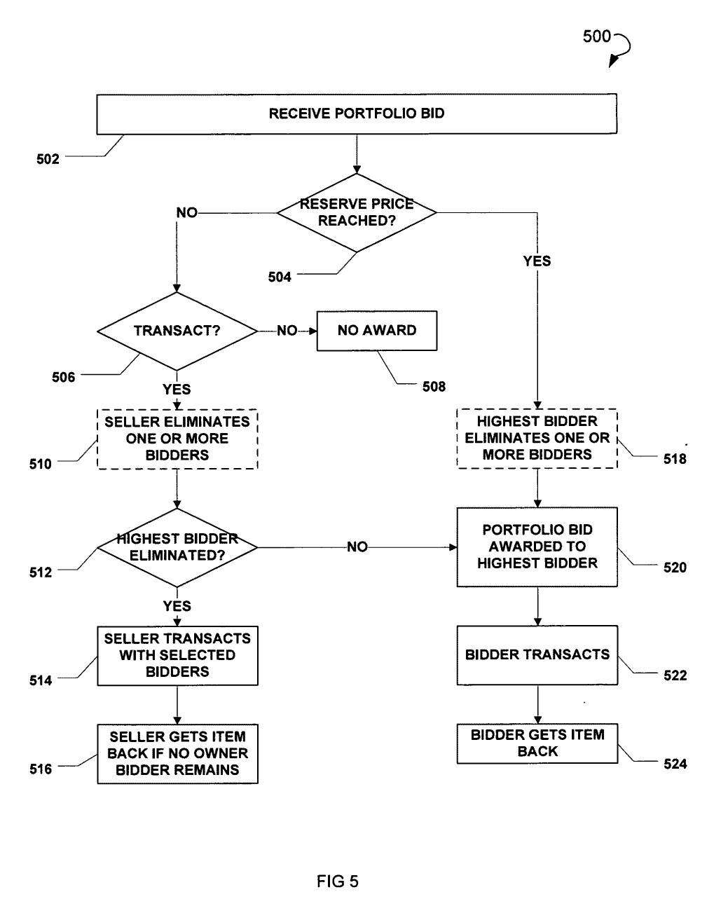

FIG. 5 is a flow chart showing a method 500 for combinatorial portfolio aggregations in electronic trade, in accordance with an example embodiment. The method 500 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2. The method 500 may be performed by the various modules discussed above with reference to FIG. 2. Each of these modules may comprise processing logic.

The method 500 may commence at operation 502 with the awarding module 206 receiving a portfolio bid. As already mentioned above, a portfolio bid is an aggregation in a single bid the highest bids for respective non-concurring possessions of an item and the bid to own the item. At decision block 504, the processing module 208 can determine whether or not the reserve price published by the seller is reached. If it is determined that the reserve price is reached, the highest bidder can be permitted to eliminate one or more bidders at operation 518. If on the other hand, it is determined that the reserve price is not reached, the seller can decide at operation 508 whether or not to award the item to the portfolio bid. If the seller decides not to award the item, the auction ends with no winner at operation 508.

If, on the other hand the seller decides to award the item, the seller can optionally eliminate one or more bidders at operation 510. At decision block 512, it can be determined whether or not the highest bidder is eliminated. If it is determined that the highest bidder is eliminated, the seller can award the item to the remaining bidders according to their respective bids. At the conclusion of all leases, the seller receives the possession of the item as shown at operation 516 if owner all owner bidders were eliminated during the auction process. Otherwise, the item will go the highest owner bidder. In some example embodiments, the seller may choose not to get the item back and, instead, sell the item to a bidder selected from the portfolio bid bidders. If, on the other hand, the highest bidder is not eliminated at decision block 512, the portfolio bid can be awarded to the highest bidder at operation 520 and the highest bidder is to transact with the remaining bidders of the winning portfolio bid at operation 522. At operation 518, the highest bidder can optionally eliminate one or more bidders he deems unnecessary for the portfolio bid to remain competitive. At the conclusion of all leases, the highest bidder receives the possession of the item as shown at operation 524. In some example embodiments, the highest bidder can forfeit his ownership to the benefit of the next highest bidder. The next highest bidder can similarly surrender the ownership to the next highest bidder and so forth until the last bidder.

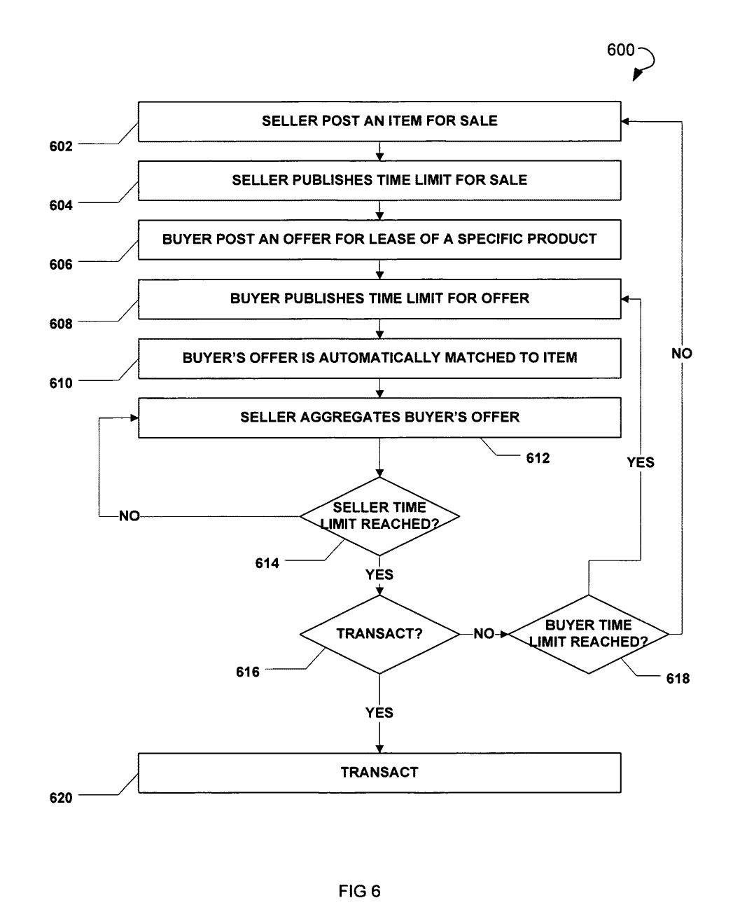

FIG. 6 is a flow chart showing a method 600 for combinatorial portfolio aggregations in electronic trade, in accordance with an example embodiment. The method 600 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic trade engine 200 illustrated in FIG. 2. The method 600 may be performed by the various modules discussed above with reference to FIG. 2. Each of these modules may comprise processing logic.

The method 600 may commence at operation 602 with the seller posting an item for sale. At operation 604, the seller can publish the time limit for the sale of the item. The time limit can indicate the date at which the winner is to be determined. At operation 606, a buyer can post an offer to lease or own a specific product. This offer can be posted at the same marketplace as the offer posted by the seller. The buyer can provide a time limit for his offer at operation 608. The time limit is the date by which the offer is to be accepted. At operation 610 the seller's offer can be matched to the buyer's offer automatically. In some example embodiments, the buyer and/or the seller can manually match their offers. The seller can receive one or two further offers and aggregate the offers at operation 612. In some example embodiments, the seller can use the bids aggregated in the previous iteration and re-aggregate the previous bids with the new bids.

At decision block 614, it can be determined whether or not the time limit specified by the seller is reached. If it is determined that the time limit is reached, the seller can decide whether or not to transact with the bidders associated with the aggregated bid. If the seller decides to transact, the seller will award the item to the winning aggregated bid. If, on the other hand, the seller decides not to transact, the method can proceed to decision block 618 where it can be determined whether the time limit associated with buyer's offer has expired. If the time limit has not expired, the seller can repost the item for sale and re-enter the buyer's bid in an aggregated bid.

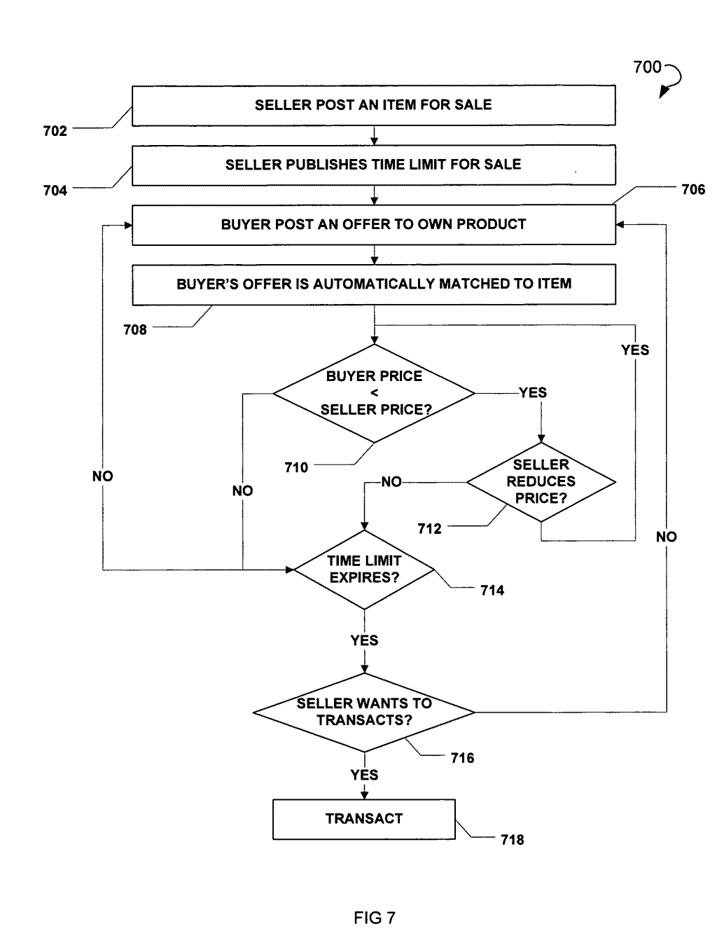

FIG. 7 is a flow chart showing a method 700 for combinatorial portfolio aggregations in electronic trade, in accordance with an example embodiment. The method 700 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2. The method 700 may be performed by the various modules discussed above with reference to FIG. 2. Each of these modules may comprise processing logic.

The method 700 may commence at operation 702 with a seller posting an item for sale. At operation 704, the seller can publish a time limit for the sale. At operation 706, a buyer can post an offer to own a product. The buyer may not specify any time limit on its offer. At operation 708, the buyer's offer can be automatically matched to the item posted by the seller. At decision block 710, it can be determined whether or not the buyer's price limit is less than the seller's price limit. If the buyer's price limit is less than the seller's price limit, the buyer can reduce its price. At decision block 712, it can be determined whether or not the buyer has reduced the price. If the buyer has reduced the price, the method 700 can return to decision block 710 to determine whether the buyer's price is now less than the seller's price. If, at decision block 710, it is determined that the buyer's price is less than the seller's price, the method can proceed to decision block 714 to determine whether the time limit has expired. If the time limit has expired, a transaction can occur at operation 718. If the seller does not reduce the price at decision block 712, the method 700 can proceed to decision block 714. At decision block 714, the processing module 208 can determine whether the time limit established by the seller expires. If the time limit expires, the method 700 can proceed to decision block 716. At decision block 716, the processing module 208 can determine whether seller wants to transact notwithstanding the fact that the buyer's price is below the seller's price. If the seller wants to transact, the transaction occurs at operation 718. Otherwise, the method 700 proceeds to operation 706 where the buyer can repost his offer.

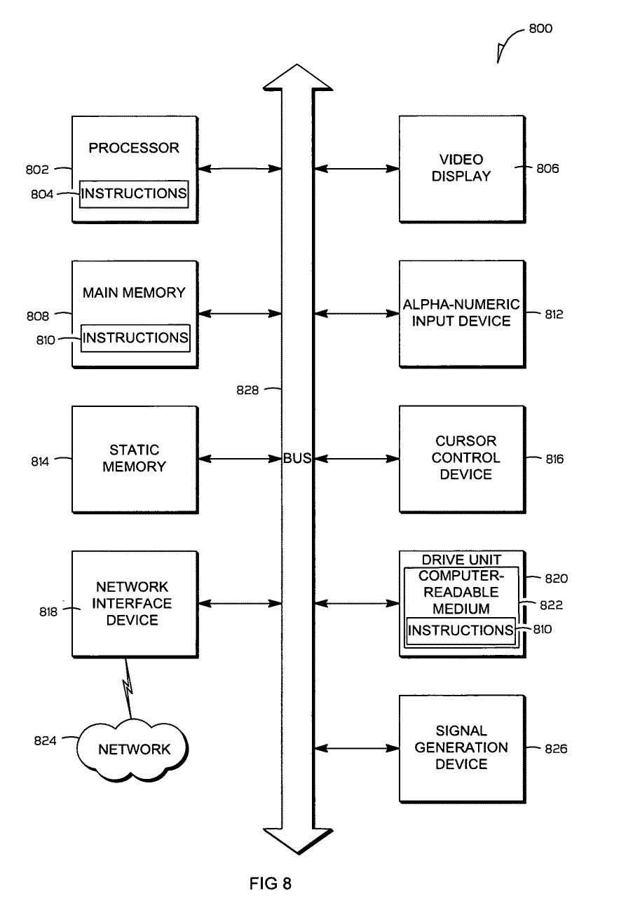

FIG. 8 is a diagrammatic representation of an example machine in the form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a mobile telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), and a main memory 808 and static memory 814, which communicate with each other via a bus 828. The computer system 800 may further include a video display unit 806 (e.g., a liquid crystal display (LCD)). The computer system 800 may also include an alphanumeric input device 812 (e.g., a keyboard), a cursor control device 816 (e.g., a mouse), a disk drive unit 816, a signal generation device 826 (e.g., a speaker) and a network interface device 818.

The disk drive unit 820 includes a computer-readable medium 822 on which is stored one or more sets of instructions and data structures (e.g., instructions 810) embodying or utilized by any one or more of the methodologies or functions described herein. The instructions 810 may also reside, completely or at least partially, within the main memory 808 and/or within the processors 802 during execution thereof by the computer system 800. The main memory 808 and the processors 802 may also constitute machine-readable media.

The instructions 810 may further be transmitted or received over a network 824 via the network interface device 818 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, methods and systems for combinatorial portfolio aggregations in electronic trade have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method, the method comprising:
receiving data associated with an offer for possession of at least one part of an item for a period of time;
receiving further data associated with at least one further offer for possession of the at least one part of the item for at least one further period of time, the time period and the at least one further period of time being non-concurrent;
selectively aggregating the offer with the at least one further offer into a portfolio offer for the at least one part of the item; and
based on predetermined criteria, determining that the portfolio offer is a winning portfolio offer.

2. The computer-implemented method of claim 1, further comprising awarding the at least one part of an item to one or more bidders associated with the winning portfolio offer.

3. The computer-implemented method of claim 2, wherein awarding of the at least one part of the item is being conditional on the portfolio offer reaching a predetermined reserve price.

4. The computer-implemented method of claim 2, wherein a party associated with the offer can eliminate the at least one further offer when portfolio offer exceeds the predetermined reserve price.

5. The computer-implemented method of claim 4, wherein the predetermined reserve price can be lowered by a seller.

6. The computer-implemented method of claim 1, wherein the aggregating continues until a predetermined time limit expires.

7. The computer-implemented method of claim 1, wherein the data associated with the offer includes an indication that the offer can be aggregated with the at least one further offer.

8. The computer-implemented method of claim 1, wherein the period of time and the at least one further period of time can be selected from a group consisting of temporary periods of time and a permanent period of time.

9. The computer-implemented method of claim 8, further enabling a party associated with the permanent period of time to modify the criteria of the aggregating of the portfolio bid.

10. The computer-implemented method of claim 8, wherein the permanent period of time starts on a predetermined future date.

11. The computer-implemented method of claim 1, wherein the item can be automatically selected from at least one listing of a product, the product being a plurality of items similar to the item.

12. The computer-implemented method of claim 1, wherein the offer is a monetary offer.

13. The computer-implemented method of claim 1, wherein the offer is a non-monetary offer.

14. The computer-implemented method of claim 1, wherein the offer is one or more of the following: a barter offer, an auction offer, and a sale offer.

15. The computer-implemented method of claim 1, further comprising informing parties associated with the offer and the at least one further offer that an acceptance of the offer constitutes an agreement to pay predetermined fines upon defaulting.

16. A computer-implemented system comprising:
a receiving module to:
receive data associated with an offer for possession of at least one part of an item for a period of time;
receive further data associated with at least one further offer for possession of the at least one part of the item for at least one further period of time, the time period and the at least one further period of time being non-concurrent;
an aggregating module to selectively aggregate the offer with the at least one further offer into a portfolio offer for the at least one part of the item; and
a processing module to determine that the portfolio offer is a winning portfolio offer based on predetermined criteria.

17. The computer-implemented system of claim 16, further comprising an awarding module to award the at least one part of an item to one or more bidders associated with the winning portfolio offer.

18. The computer-implemented system of claim 17, wherein the awarding module is to award the at least one part of the item based on the portfolio offer reaching a predetermined reserve price.

19. The computer-implemented system of claim 17, wherein a party associated with the offer can eliminate the at least one further offer when the portfolio offer exceeds the predetermined reserve price.

20. A machine-readable medium comprising instructions, which when implemented by one or more processors, perform the following operations:
receive data associated with an offer for possession of at least one part of an item for a period of time;
receive further data associated with at least one further offer for possession of the at least one part of the item for at least one further period of time, the time period and the at least one further period of time being non-concurrent;
selectively aggregate the offer with the at least one further offer into a portfolio offer for the at least one part of the item; and
based on predetermined criteria, determine that the portfolio offer is a winning portfolio offer.
